(19) United States
(12) Patent Application Publication
(10) Pub. No.: US 2016/0264088 A1
(43) Pub. Date: Sep. 15, 2016

(54) METHOD FOR ACTIVATING AT LEAST ONE PROTECTIVE ELEMENT ARRANGED IN A VEHICLE SEAT

(71) Applicant: DAIMLER AG, Stuttgart (DE)

(72) Inventors: Edgar BIHLER, Gärtringen (DE); Ralf BOGENRIEDER, Stuttgart (DE); Julien RICHERT, Stuttgart Vaihingen (DE)

(21) Appl. No.: 15/032,742

(22) PCT Filed: Sep. 19, 2014
(86) PCT No.: PCT/EP2014/002547

§ 371 Date: Apr. 28, 2016

(30) Foreign Application Priority Data
Oct. 29, 2013 (DE) 102013017957.2

(51) Int. Cl. B60R 21/0134; B60N 2/02; B60N 2/427; B60N 2/42

(52) U.S. Cl. CPC B60R 21/0134; B60N 2/4235; B60N 2/0276; B60N 2/4279; B60R 2021/0006

(57) ABSTRACT

A method is provided for controlling at least one protective element arranged in a vehicle seat for positioning a passenger sitting on the vehicle seat, wherein the at least one protective element is triggered by control of an actuator in the case of a detected imminent collision of the vehicle. After non-detection of an imminent collision of the vehicle and of a subsequently detected occurred collision of the vehicle, the at least one protective element is triggered by control of the irreversibly executed actuator at or after a collision time.

### BACKGROUND AND SUMMARY OF THE INVENTION

Exemplary embodiments of the invention relate to a method for controlling at least one protective element arranged in a vehicle seat for the positioning of a passenger sitting on the vehicle seat, wherein the at least one protective element is triggered by control of an actuator if an imminent collision of the vehicle is detected.

German patent document DE 10 2010 007 242 A1 discloses a vehicle seat arrangement to protect a vehicle passenger of a vehicle, in particular a passenger motor vehicle. In the vehicle seat arrangement, at least one protective element, which is arranged on a vehicle seat and is able to be triggered to protect the vehicle passenger located on the vehicle seat, is able to be triggered in the event of an imminent collision or during a collision. Here, the vehicle seat has at least two inflatable elements lying opposite each other in the side frame as support elements and only the inflatable element facing towards the expected collision point is able to be triggered depending on a control signal and is able to be inflated in the direction of the vehicle passenger. During triggering of the protective element, a pulse is exerted on the vehicle passenger or at least one body part of the vehicle passenger, due to which the vehicle passenger or at least one body part of the vehicle passenger is able to be moved away from a collision section of the vehicle that is colliding or will collide with the object. The inflatable elements are formed to be inflatable in a repeatable and reversible manner and are coupled to a gas source which is able to be exchanged, regenerated or used for repeated inflation of the protective element.

Furthermore, German patent document DE 101 50 719 A1 discloses a vehicle seat and a method to control the same in which the vehicle seat causes a sideways movement of the passenger sitting on the vehicle seat in the event of a side impact or directly before a side impact. The sideways movement occurs away from the vehicle side facing towards the impact and towards the vehicle center, wherein, for the sideways movement, at least one seat cushion is able to be moved transversely, separately relative to other seat components and relative to the seat attachment.

Additionally, German patent document DE 10 2010 052 412 A1 discloses a method and a device to protect a vehicle passenger in a vehicle seat of a vehicle, in particular a passenger motor vehicle. The method provides that at least one protective element, which is arranged on the vehicle seat and is able to be triggered to protect the vehicle passenger located on the vehicle seat, is triggered in the event of an imminent collision or during a collision. During triggering of the protective element, a movement pulse is exerted on the vehicle passenger or at least one body part of the vehicle passenger, using which the vehicle passenger or at least the body part of the vehicle passenger is moved away from a collision section of the vehicle that is colliding or will collide with the object. An intensity of the movement pulse varies here depending on a determined accident severity and/or a determined accident type.

Furthermore, German patent document DE 10 2010 032 449 A1 describes a method and a device to protect a vehicle passenger of a vehicle having a vehicle seat, wherein in the event of an imminent collision or during a collision, a degree of filling of an inflatable side holding insert of a side frame of the vehicle seat is controlled. During a side collision or in the case of detection of an imminent side collision, the first side holding insert arranged in the side frame facing away from the collision side is vented, such that the vehicle passenger is moved away or is able to be moved away from the collision side.

Exemplary embodiments of the invention are directed to an improved method compared to prior art to control at least one protective element arranged in a vehicle seat.

A method for controlling at least one protective element arranged in a vehicle seat for positioning a passenger sitting on the vehicle seat provides that the at least one protective element is triggered by control of an actuator in the event of a detected imminent collision of the vehicle. According to the invention, after non-detection of an imminent collision of the vehicle and a subsequently detected occurred collision of the vehicle, the at least one protective element is irreversibly triggered by control of the actuator at or after a collision time.

Since the at least one protective element is also triggered in the case of a non-recognised imminent collision of the vehicle at or after the collision time, the passenger on the vehicle seat obtains a movement pulse, whereby the passenger is positioned in the direction of the vehicle center. An initial position of the passenger on the vehicle seat is thereby substantially improved in a particularly advantageous manner with regard to a possible secondary impact of the vehicle. In turn, a risk of injury of the passenger can thereby at least be reduced.

If the vehicle rolls over and the passenger is moved in the direction of the vehicle center by means of the triggered protective element, the risk of contact between the passenger and the vehicle interior can likewise be at least reduced.

Additionally, the use of an irreversible actuator to trigger the at least one protective element is more cost-effective than a reversible actuator.

Particularly preferably, the actuator is triggered pyrotechnically, wherein the actuator is a gas generator having a pyrotechnic propellant. Since this is an actuator that is able to be triggered in a pyrotechnic manner, to trigger the same, advantageously only an ignition pulse is required which, in particular, is generated as an ignition signal of an airbag control device of the vehicle and is supplied to the actuator.

In a preferred embodiment, the at least one protective element is triggered in the event of a detected imminent side collision of the vehicle, a detected occurred side collision and/or a detected roll-over of the vehicle. By means of the triggered protective element, a movement pulse is exerted on the passenger such that this is positioned in order to at least reduce a risk of injury for the passenger.

Advantageously, the at least one protective element is triggered after triggering a side airbag, such that the passenger is protected by means of the side airbag during a first collision, and the positioning of the passenger, acting from the movement pulse by the protective element, in the direction of the vehicle center, in particular in the event of a secondary collision of the vehicle, is of use for the passenger with regard to the reduction of the risk of injury.

Preferably, the at least one protective element is triggered depending on a detected collision severity, such that the passenger is moved away from a collision side of the vehicle by means of the protective element if a corresponding degree of severity is present with regard to the collision.

In a further preferred embodiment, the at least one protective element is triggered by means of detected signals of an environment detection sensor system and by means of detected signals of a collision sensor system such that, in a particularly advantageous manner, it is achieved that the protective element is either triggered in the event of a detected imminent collision of the vehicle or in the event of a detected occurred collision, whereby the movement pulse acting on the passenger is generated.

Preferably, an air cushion arranged in a side frame of the vehicle seat is inflated as a protective element, wherein an air cushion is preferably arranged in a respective side frame, the air cushion being impinged with a gas by means of the irreversible actuator, and the air cushion is therefore inflated. The air cushion is unfolded, whereby the movement pulse is exerted on the passenger in order to move the passenger away from the collision side of the vehicle, for example.

Furthermore, the method provides that, to trigger the at least one protective element, passenger-relevant parameters are detected, which are considered in relation to the triggering of the protective element. If the passenger, for example, is a person with comparably low body weight, then, for example, the protective element in the form of an air cushion is unfolded less quickly such that a movement pulse that is not quite as strong is exerted on the passenger and a risk of injury of the passenger by the protective element itself is thereby reduced.

### BRIEF DESCRIPTION OF THE DRAWING FIGURES

Exemplary embodiments of the invention are explained in more detail below by means of drawings.

Here are shown:

FIG. 1 schematically, a first method sequence to control a protective element arranged in a vehicle seat,

FIG. 2 schematically, a second method sequence to control the protective element arranged in the vehicle seat,

FIG. 3 schematically, a third method sequence to control the protective element arranged in the vehicle seat,

Parts which correspond to one another are provided with the same reference numerals in all figures.

### DETAILED DESCRIPTION

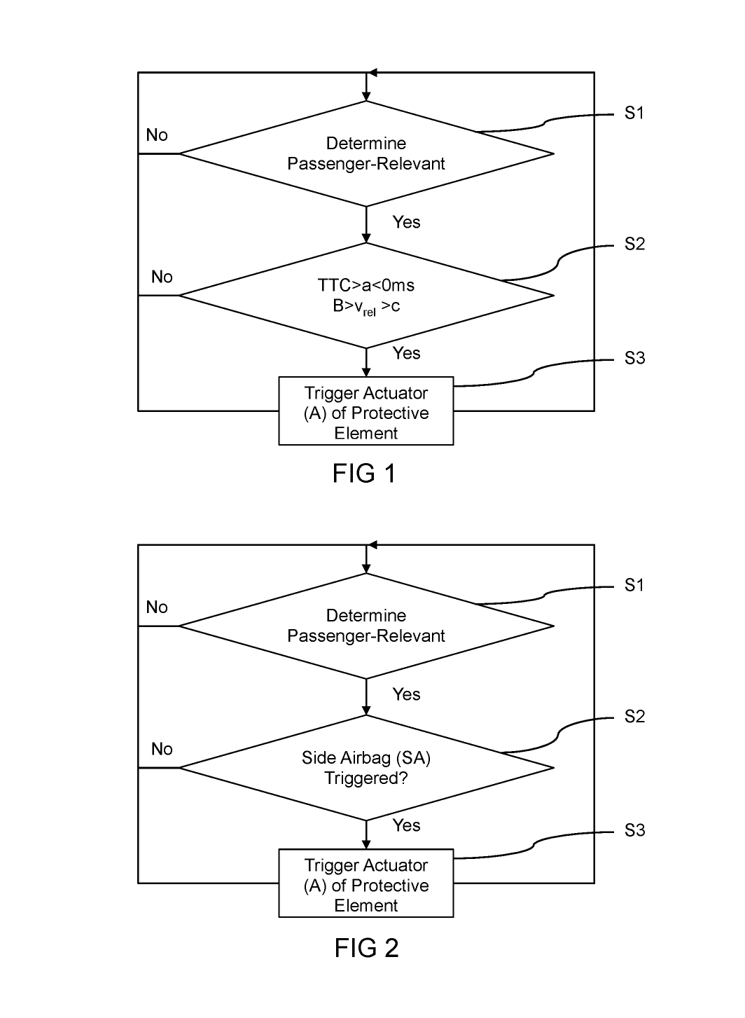

FIG. 1 shows a first method sequence to control a protective element arranged in a vehicle seat. The protective element is an inflatable air cushion arranged in a side frame of the vehicle seat.

The protective element is triggered by an irreversible, in particular pyrotechnic, actuator, wherein this is a pyrotechnic gas generator. The gas generator comprises a pyrotechnic propellant that is ignited by an ignition pulse in the form of an ignition signal generated by an airbag control device. Gas is thereby released, by means of which the protective element in the form of the air cushion is unfolded.

The airbag control device is connected to an environment detection sensor system and a collision sensor system of the vehicle.

The surrounding environment of the vehicle is able to be detected by the environment detection sensor system, which has a number of detection units arranged in and/or on the vehicle. For example, one of the detection units functions or several of the detection units function on the basis of radar. The detected signals of the environment detection sensor system, for example, can be used to determine that there is a collision imminent for the vehicle.

An actually occurred collision can be detected by the collision sensor system, which also has a number of detection units arranged in and/or on the vehicle. For this purpose, the detection units are, for example, acceleration sensors, pressure sensors and/or inclination sensors.

In the first method sequence, a triggering of the support element is depicted which is based on detected signals of the environment detection sensor system.

Signals are continuously detected by the environment detection sensor system and are supplied to the airbag control device for evaluation and processing. If a potential collision object is detected within the environment, a relative speed v_{ref} between the vehicle and the potential collision object is determined. A probability of an occurrence of a collision, in other words a side collision, with this collision object can thereby be determined.

Furthermore, it is possible, using the detected signals and the determined relative speed v_{ref}, to determine a collision time for an occurrence of the side collision.

In a first step S1 of the first method sequence, passenger-relevant parameters IP, such as, for example, a belt status, a seat position, a passenger position and/or a passenger weight, are determined.

In particular, it can be determined by the belt status whether a belt tongue of a safety belt allocated to the vehicle seat is inserted into a belt buckle. It can thereby be determined, on the one hand, whether a passenger is sitting on the corresponding vehicle seat and, if so, whether the passenger has applied the safety belt.

If it is determined based on the detected passenger-relevant parameters IP, among other things, that the vehicle seat is occupied, in a second step S2, two threshold value queries are carried out and the detected signals of the environment detection sensor system are tested for plausibility with regard to the detected imminent collision of the vehicle.

On the one hand, a threshold value query is carried out and it is determined whether a predetermined first threshold value a is smaller than a determined collision time TTC and whether the first threshold value a is smaller than a predetermined time value of, for example, 0 ms.

And, on the other hand, a threshold value query is carried out and it is determined whether the determined relative speed v_{ref} between the vehicle and the detected potential collision object is smaller than a second threshold value b and greater than a third threshold value c.

As described above, in the second step S2, the testing for plausibility of the detected signals with regard to the determined imminent collision of the vehicle occurs, wherein, for this purpose, for example, the continuously detected signals are checked.

If the first threshold value a is smaller than a determined collision time TTC and smaller than 0 ms, and the relative speed v_{ref} is smaller than a second threshold value b and greater than a third threshold value c and the detected signals were tested for plausibility, a control signal in the form of an ignition signal is generated by the airbag control device and the pyrotechnic triggering A of the actuator of the protective element occurs in a third step S3. The protective element is impinged with the gas of the actuator, whereby the protective element unfolds and thereby exerts a movement pulse on the passenger such that this passenger is moved away from a collision side or a collision section of the vehicle, whereby a risk of injury of the passenger can be at least reduced.

FIG. 2 shows a second method sequence to control the protective element.

In the present exemplary embodiment according to FIG. 2, no imminent collision of the vehicle, in particular side collision, was detected by the environment detection sensor system, for example due to a defect.

The vehicle collides laterally with a collision object, wherein the passenger-relevant parameters IP were previously detected in a first step S1 of the method. The collision was determined using the detected signals of the collision sensor system of the vehicle, wherein a collision severity is determined at the same time by means of the detected signals.

If the determined collision severity exceeds a further threshold value (not depicted in more detail), the side airbag SA of the vehicle is triggered in a second step S2, in order to prevent contact of the passenger with vehicle parts, in particular the B pillar, the collision side or the collision section of the vehicle as much as possible, and therefore to reduce the risk of injury.

The side airbag SA was triggered since the protective element was not triggered before the collision; the ignition signal is now generated by the airbag control device and is supplied to the actuator to trigger A the same in a third step S3.

The protective element is triggered after the occurrence of the collision, whereby in the event of a second impact on the vehicle, in the event of a so-called secondary collision, a protective effect for the passenger can be achieved.

After occurrence of the first collision, the passenger is moved in the direction of the vehicle center by the protective element such that the passenger is at a distance to the collision side in the event of a secondary collision. In other words, an initial position of the passenger is improved by the triggered protective element in the event of a second collision of the vehicle.

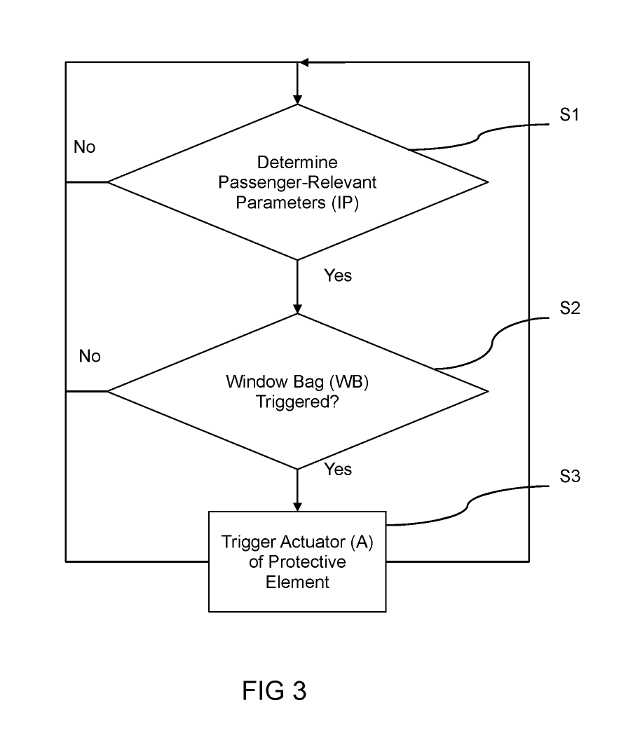

A third method sequence depicted in FIG. 3 to control the protective element provides, in a first step S1, the detection of the passenger-relevant parameters IP.

The vehicle is threatening to roll over, wherein the imminent roll-over is detected by the collision sensor system.

A so-called window bag WB arranged in the vehicle is triggered due to an exceeding of a fifth threshold value (not depicted in more detail) in a second step S2 of the method. For example, the triggered window bag WB substantially prevents the passenger from being ejected from the vehicle window or extremities of the passenger hang out of the vehicle window and further health risks would thereby result for the passenger.

After a triggering of the window bag WB, the ignition signal is generated by the airbag control device and is supplied to the pyrotechnic actuator of the protective element such that the trigger A occurs. The protective element is inflated, whereby the passenger is moved in the direction of the vehicle center. The risk of contact between the passenger and the vehicle interior is thereby prevented, whereby the probability of injury can likewise be prevented for the passenger.

It can also be provided with regard to the detection of the passenger parameters IP that the trigger A of the protective element occurs, adapted accordingly, for example, depending on the detected passenger position and/or a detected passenger size.

The individual method sequences described in FIGS. 1 to 3 describe a logic to control the actuator of the protective element, wherein the logic is implemented in the airbag control device and/or another control device, wherein the signals continuously detected by the environment detection sensor system and the collision sensor system are supplied to the airbag control device and/or to the other control device via a bus system arranged in the vehicle, and are therefore available.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-8. (canceled)

9. A method, comprising:
determining that an imminent collision of a vehicle is not detected and that subsequently a collision of the vehicle is detected; and
in response to the determination, irreversibly triggering at least one protective element using actuator at or after a collision time,
wherein the at least one protective element is in a vehicle seat of the vehicle for positioning a passenger sitting on the vehicle seat and the at least one protective element is triggered by control of an actuator in the event of a detected imminent collision of the vehicle.

10. The method of claim 9, wherein the actuator is pyrotechnically triggered.

11. The method of claim 9, wherein the at least one protective element is triggered in the event of a detected imminent side collision of the vehicle, a detected occurred side collision and/or a detected roll-over of the vehicle.

12. The method of claim 9, wherein the at least one protective element is triggered after triggering of a side airbag.

13. The method of claim 9, wherein the at least one protective element is triggered depending on a determined collision severity.

14. The method of claim 9, wherein the at least one protective element is triggered in response to detected signals of an environment detection sensor system and detected signals of a collision sensor system.

15. The method of claim 9, wherein the at least one protective element is an inflatable air cushion arranged in a side frame of the vehicle seat.

16. The method of claim 9, wherein the determination of whether to trigger the at least one protective element is based on detected passenger-relevant parameters.

17. A method, comprising:
continuously determining whether an imminent collision of a vehicle is detected and whether a collision of the vehicle is detected,
wherein when a collision of the vehicle is detected, which is preceded by a determination that an imminent collision is not detected,
irreversibly triggering at least one protective element using actuator at or after a collision time,
wherein the at least one protective element is in a vehicle seat of the vehicle for positioning a passenger sitting on the vehicle seat and the at least one protective element is triggered by control of an actuator in the event of a detected imminent collision of the vehicle.

18. The method of claim 17, wherein the actuator is pyrotechnically triggered.

19. The method of claim 17, wherein the at least one protective element is triggered in the event of a detected imminent side collision of the vehicle, a detected occurred side collision and/or a detected roll-over of the vehicle.

20. The method of claim 17, wherein the at least one protective element is triggered after triggering of a side airbag.

21. The method of claim 17, wherein the at least one protective element is triggered depending on a determined collision severity.

22. The method of claim 17, wherein the at least one protective element is triggered in response to detected signals of an environment detection sensor system and detected signals of a collision sensor system.

23. The method of claim 17, wherein the at least one protective element is an inflatable air cushion arranged in a side frame of the vehicle seat.

24. The method of claim 17, wherein the determination of whether to trigger the at least one protective element is based on detected passenger-relevant parameters.
